(19) United States
(12) Patent Application Publication
(10) Pub. No.: US 2009/0065637 A1
(43) Pub. Date: Mar. 12, 2009

(54) Buoyancy system using double-sorb controllers for engine fueling and airship attitude correction

(76) Inventors: Robert V. Duncan, Columbia, MO (US); Tillman Desawyer McCarson, JR., Albuquerque, NM (US); Anatoly I. Efremov, Albuquerque, NM (US)

Correspondence Address: Robert Duncan;Swift Air LNG, LLC, 443 South Humboldt Street, Denver, CO, 80209, US

(21) Appl. No.: 12/231,842

(22) Filed: Sep. 6, 2008

Related U.S. Application Data
(60) Provisional application No. 60/993,037, filed on Sep. 10, 2007.

(51) Int. Cl. B64B 1/58

(52) U.S. Cl. 244/97

(57) ABSTRACT

A buoyancy system using double-sorb controllers for engine fueling and airship attitude control is disclosed. The buoyancy system is based on the use of a Liquefied Natural Gas (LNG) payload that assists in buoyancy control and provides simultaneously a fuel for natural gas engines that propel the airship. The airship attitude correction is achieved by changing the amount of buoyant gas such as methane that is enclosed in the airship's baffles located forward and aft in the airship, and to the starboard and port if necessary for active roll control. The airship attitude control is provided by absorption or desorption of the natural gas using two double-sorb controllers. One of two double-sorb controllers is mounted forward and the other is mounted aft in the airship, so the differential absorption/desorption of natural gas is used to control the pitch of the airship. Each double-sorb controller consists of a thermally insulated external container connected with the LNG payload and natural gas engines. The double-sorb controller includes two sorbs equipped with heaters and separated by vacuum space and thermally conductive shell. The first sorb is connected with the airship's baffle to absorb or desorb the natural gas enclosed in the baffle, and the second sorb is connected to the natural gas engine. The LNG payload controls the level of the vacuum in a space that completely surrounds the first sorb. By the regulation of temperature increase or decrease of two sorbs within the double-sorb controllers, the fueling of the natural gas engines and the airship attitude control is achieved. A second system may be used to plumb the natural gas boil-off into or out of each baffle as necessary to provide course control of the overall airship, and buoyancy and attitude control. Other liquefied or solidified gases such that the gas phase of the material is lighter than air, such as hydrogen, may be substituted for natural gas in this invention. All lighter than air airships, including but not limited to blimps, may be controlled using the invention described herein.

### CROSS-REFERENCE TO RELATED APPLICATIONS

This Patent Application is the continuation of an earlier application of, and claims the benefit of the filing date of, U.S. Provisional Patent Application Ser. No. 60/993,037 entitled “Buoyancy System Using Double-sorb Controllers for Engine Fueling and Airship Attitude Correction” filed on Sep. 10, 2007.

### FEDERALLY SPONSORED RESEARCH

None

### SEQUENCE LISTING

None

### BACKGROUND OF THE INVENTION

1. Field of the Invention

The present invention relates to self-propelling airships as blimps which float for a long period of time with supply of fuel for natural gas engines from the Liquefied Natural Gas (LNG) payload that assists simultaneously in buoyancy control of the airships.

2. Prior Art

A modern method to transport LNG consists of the replacement of conventional tanker-ship delivery by small-scale delivery using insulated custom-designed dewars containing LNG. These dewars will be ganged on trusses for airlift by a new type of airship. These airships will use the boil-off from the LNG dewars to provide the buoyant gas to lift the airship and simultaneously to feed the internal combustion engines that propel the airship. Methane, the main component of the LNG, has a mass of 16 grams per mole, which is significantly less than the 28 grams per mole of nitrogen that is the chief component of the surrounding atmosphere. Hence, the LNG being converted into its gas state by evaporation may be used in an airship to produce the necessary buoyancy. Moreover, the LNG in its liquid state is less dense than water, so if the airship has to ditch in the open ocean, the LNG payload will float, so the cargo may be located and recovered using conventional ELT transmitters or other locator devices.

Traditional shipment methods lose up to 10% of the LNG cargo that was loaded in the Middle East during shipments to North American or Japanese ports. The new small-scale delivery by airships, propelled with natural gas engines, will reduce this boil-off to no more than 2% on the same distance routes. These airships will fly at high altitude in the direction of the prevailing jet stream to greatly reduce the required energy for shipment. Once these LNG dewars have been delivered they will be reconfigured on other trusses for railcar or truck transport to LNG and/or Compressed Natural Gas (CNG) refueling stations. This delivery system will avoid the complexity and risk of conventional LNG pumping, and it will save the substantial losses associated with shrinkage in transit and in the recompression that is required to the CNG pressures from gas pipeline distribution systems. This new system of LNG delivery will not require infrastructure support of gas pipeline capability at the point of distribution to the end market, and it will permit the rapid commercialization of natural gas as vehicle fuel in markets without a natural gas pipeline system.

Certain airships, such as blimps, routinely change their angle of attack to convert atmospheric conditions such as a thermally driven updraft of the surrounding air into more forward motion, much in the same way that dolphins swim. This subject invention of attitude control may be used to provide the necessary periodic changes in the attitude of attack that are necessary to propel the airship forward.

The described LNG delivery procedure is a new delivery technology, so that only a few patent documents may be considered as prior art of the invention presented below.

The U.S. Pat. No. 5,348,254 by Nakada proposes an airship of semirigid type which floats without supplying energy powered only by a solar cell battery in the daytime and by hydrogen engine in the nighttime. In this invention a rigid keel is disposed within an envelope, and a central buoyant cell is supported by the keel through nets or cords that permits an adequate distribution of the weight of the airship.

The central buoyant cell is divided into three compartments, and hydrogen enclosed therein may be transferred from one to the other to improve trim of the airship. Simultaneously, the use of hydrogen as a lifting gas allows utilizing the hydrogen in the buoyant cell as a fuel for hydrogen engine at nighttime. The decrease of a buoyant force due to the cooled airship is compensated by recovering the exhaust heat of the engine. The separated water is stored in a water tank, the exhaust gas being freed into the envelope through an exhaust pipe. Hydrogen enclosed within the buoyant cell is completely isolated from the external air of the envelope to prevent explosion. Ascent and descent of the airship is possible by displacing hydrogen in the buoyant cell to the nose or tail compartment.

The electric power generated in a solar cell is transmitted to a storage battery, a water electrolyzer and propulsion motor. Hydrogen produced by the electrolyzer is transferred to the buoyant cell through a hydrogen pipe, and oxygen as a by-product is discharged via an oxygen outlet.

The GB Pat No. 1,532,411 by Pope discloses an apparatus for regulating buoyancy of an underwater diver in relation to ambient pressure in the water. The invention utilizes control means to pass gas into and out of a chamber of variable volume thus to vary displacement of the chamber in the fluid, so that the buoyancy may be negative (descent), positive (ascent) or neutral for a desired operational depth.

A cargo-gas airship is described in the U.S. Pat. No. 3,706,433 by Sonstegaard. The airship is flying at higher altitudes when it is empty of cargo-gas than when it is loaded therewith, even though the permanent lifting-gas chamber is sized only for the lower altitudes required for loaded flight. High-altitude capability on empty flights is obtained by transferring a portion of the lifting gas from the permanent lifting-gas chamber to the high-altitude lifting-gas chamber.

An underwater self-propelled buoyant apparatus for burying a pipeline or cable is described in the U.S. Pat. No. 3,926,003 by Norman et al. Buoyant outrigger compartments on each side of the apparatus adjust the attitude of the apparatus over the pipeline. Each compartment is open at the bottom to the water and is provided also at the bottom with a gaseous inlet and at the top with a gaseous outlet to control the level of the water in each compartment.

Some patent documents relate to methods for the controlled absorption, desorption and distribution of cryogenic fluids, and are summarized as follows.

A gas storage and dispensing system is described in the U.S. Pat. No. 5,301,851 by Frutin. The system comprises a material having open voids occupied by a liquid. The material may be a porous material, for example a foam such as polymeric foam, having an open pore structure, and the open voids comprise the pores of material. Alternatively, the material may comprise a fibrous component wherein the open voids comprise the space between the fibres of the material. Moreover, it is possible the material may be a liquid-type foam, or non-rigid solid material with substantially elastic mechanical properties, and the total mass of the material involved in any gas storage system may be mechanically subdivided into a substantial plurality of fragments. The material may be treated with a swelling promoter to enhance the gas sorption capacity of the material.

The open voids in the material function as small scale stores for the liquid solvent of the gas, i.e. the material functions as a form of “sponge” which indirectly holds the gas by the gas being in solution in the liquid. The analogy to a “sponge” is supported by tendency of suitable materials to swell when storing gas, where a liquid is also present.

The liquid is a solvent of the gas and such occupation of the open voids by the liquid, with the gas dissolved therein, forms a reversible sorption gas storage system. The system tends to sorb increasing quantities of gas in increasing ambient gas pressure and desorb previously sorbed gas with decrease in ambient gas pressure.

The US Pat. Application No. 2006/0191287 by Maier-Laxhuber discloses a cooling sorption element with a sorbent material which in vacuum can sorb a vaporous working medium that evaporates from a fluid working medium in an evaporator. A shut-off means which, up to the moment at which the cooling process is initiated, prevents the working medium vapor from flowing into the sorbent material that is sealed into a sorbent-containing pouch. The sorbent-containing pouch comprises a multilayer sheeting material which in turn comprises a metallic layer or metalized layer.

A composite material capable of hydrogen sorption is described in the US Pat. Application No. 2004/0101686 by Paolo della Porta et al. A powder of a composite material comprising a non-evaporable getter (NEG) material with a palladium coating continuously sorbs hydrogen. The coverage of the palladium coating over the particles of the NEG material is complete and can sorb hydrogen without the need for an activation treatment. Loose powders, pressed powders and sintered powders of the composite material are incorporated into getter devices and into the evacuated spaces of double-walled pipes, dewars, and thermal bottles.

A device for sorbing large amounts of liquid by capillary action is disclosed in the U.S. Pat. No. 3,797,250 by Canevari. The device comprises a multiplicity of cylindrically shaped particles. Each particle comprises a plurality of capillary sized passageways which run the length of the particle. The particles each sorb an amount of liquid, by capillary action, equal to the volume of the capillary passageways. The particles may be used in any application requiring the sorption and retention of the liquids.

The GB Pat No. 1,293,401 by Nicholds et al. proposes a cryogenic refrigerating apparatus using a supply of liquid nitrogen that is delivered through the supply pipe to the evaporator by closing the supply vessel such as the Dewar flask, so that leakage of the heat into the refrigerant causes evaporation and rise of pressure in the Dewar. The Dewar is provided with an injector having a liquid inlet communicating with the Dewar, below the liquid surface, and a gas inlet communicating through a pressure control device with a point in the Dewar above the liquid surface to produce a flow of gas entraining drops of liquid into the Dewar.

The GB Pat. No. 1,339,524 by Bilow et al. describes a vacuum container containing a self-actuating hydrogen scavenging or hydrogen getter agent material in combination with conventional desiccant material at ambient temperature. The vacuum container provides for effecting and maintaining a sealed vacuum with a stabilized, low level of free hydrogen, and maintaining the vacuum relatively free of hydrogen evolved thereinto by components associated with the vacuum container. The vacuum sealed container can be used under cryogenic conditions, and it includes a hydrogen getter material in the vacuum space comprising an oxide or hydroxide, or hydrated oxide, or palladium or platinum, or mixtures thereof.

The U.S. Pat. No. 4,192,147 by Bentz et al. proposes an arrangement for the automatic distribution in free air of metered quantities of the liquid phase of a cryogenic fluid. The arrangement comprises a container to hold the liquid phase, a system to control the supply of the cryogenic liquid to the container, metering member, forced discharge means, means for distributing the cryogenic liquid, and a system for controlling the metering member and the discharge means.

A cryogenic fluid distribution apparatus is described in the US Pat. Application No. 2005/0086964 by Hackman et al. The apparatus includes a fluid flow passage for distributing cryogenic fluid to an object to be cooled, an overflow passage positioned downstream of the apparatus, and a sensor coupled to the overflow passage, the sensor having an active component for determining if the fluid is present in the overflow passage.

None of the above mentioned references addresses or discloses the invented subjects or approaches that relate to the present invention. Accordingly, it is a principal object of the present invention to form a novel buoyancy system using double-sorb controllers as a means for fueling natural gas engine and airship attitude correction.

### SUMMARY OF THE INVENTION

Considering the problem of buoyancy, airship attitude correction and fueling airship engines in all the deficiencies of the prior art, it is, therefore, a primary object of the present invention to form a novel buoyancy system based on the use of the LNG payload as a means for fueling natural gas engines and airship attitude control.

Another object of the invention is to provide automatic airship attitude control by means of double-sorb controllers that use natural gas distributed into baffles of the airship.

The next object of the invention is to use the double-sorb controllers to provide the necessary transport of the natural gas obtained from the LNG payload to the airship's baffles for attitude control.

Still another object of the present invention is to use the same double-sorb controllers to provide the necessary fuel for the natural gas engines.

Further brief description of applied drawings followed by a detailed description of the invention is intended to explain the principal concept of the presented buoyancy system.

### BRIEF DESCRIPTION OF THE DRAWINGS

FIG. 1 is a side-elevational view of the airship carrying the LNG dewars ganged in a truss, the dewars being connected with two double-sorb controllers, one mounted forward and one mounted aft in the airship.

FIG. 2 is a cross-sectional view of the double-sorb controller intended to feed the natural gas engines and to simultaneously control attitude of the airship.

### DETAILED DESCRIPTION OF THE INVENTION

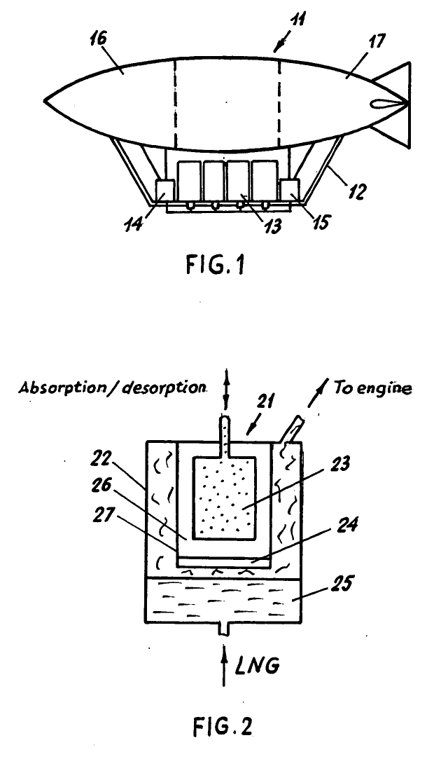

The airship (11) shown in FIG. 1 has a rigid platform (12) that carries fixed LNG dewars (13) and two double-sorb controllers (14) and (15) connected to the dewars, baffles (16) and (17) in the airship, and natural gas engines (not shown). The dewars are ganged together on the truss and they have gas phase inlets to provide their normal boil-off from LNG to the controllers that deflect this boil-off to either buoyancy baffles (16) and (17) in the airship, or to the engines, or both. The double-sorb controllers are located below the dewars' liquid surfaces to permit gravity to feed LNG to the double-sorb controllers. Routine buoyancy adjustment is made by changing the amount of natural gas that is absorbed or desorbed on one or two double-sorb controllers (14) and (15), so the differential absorption or desorption of natural gas on these two double-sorbs may be used to control the pitch and attitude of the airship. The total amount of natural gas absorbed or desorbed by the two double-sorbs will be used to set the buoyancy of the airship in a narrow range centered on neutrally buoyant. These buoyancy control systems adjust the airship's buoyancy independently from the rate at which natural gas is consumed by the engines, so this method of control will permit engine power to be treated as an independent variable without specifically having to boil more LNG from the dewars, and without having to release natural gas into the environment.

Some airships are designed without axial symmetry with a center of mass located at a certain distance from the center of lift, requiring additional control of the airship's roll. Such control may be achieved by using additional double-sorb units, for example with two controlling pitch (as described above), and two controlling the roll of the airship. This roll control may be achieved by placing natural gas filled buoyancy baffles in the outer sections of the airship, away from the axis of the airship that is aligned with the direction of motion of the airship in coordinated flight.

FIG. 2 is a schematic cross-sectional view of the double-sorb controller (21). It consists of a thermally insulated external container (22) that is connected with the LNG dewar (not shown) to receive a metered quantity of LNG. The double-sorb controller includes two sorbs (23) and (24) equipped with heaters, namely the first working sorb (23) that absorbs or desorbs natural gas from the airship's baffle (not shown), and a second sorb (24) that controls the thermal contact between the first sorb and the LNG (25) that is in a container (22) at a temperature of approximately 110 K. These two sorbs are separated by a vacuum space (26) formed by the first sorb (23) and a hermetic shell (27) inside the container (22). The second sorb (24) controls the level of vacuum in a space that completely surrounds the first sorb (23). In normal operation, an increase in the buoyancy of the airship is accomplished by increasing the temperature of the first sorb while decreasing the temperature of the second sorb that is located in the vacuum space. This results in the desorption of the natural gas from the first sorb to fill the baffle while the vacuum in the space surrounding the first sorb is pumped hard by the second sorb to provide thermal insulation from the LNG (25) to avoid excessive boil-off of the LNG.

The buoyancy of the airship may be reversed by reversing this heater control strategy. By decreasing the temperature of the first sorb, more natural gas will be absorbed from the baffle, thus reducing the buoyancy of that baffle. Typically only about 50 millitorr of gas within this vacuum space is sufficient to provide adequate heat transfer from the inner sorb to the surrounding LNG, thus enabling heat transfer through the partial vacuum space to support rapid absorption of the natural gas that is contained within the baffle onto the inner sorb. Hence, any pressure at or over 50 millitorr may be generated within the vacuum space by the second sorb when the second sorb's heater is actuated. This procedure is accompanying by increase of the rate of evaporation of the LNG since the heat sorption must be removed in large part by evaporation of the LNG, and, to a lesser extent, by the increase in enthalpy in the cold evaporation stream. This evaporating gas will be made available to the engines, so that they may increase power during this resulting descent of the airship. This additional boil-off gas may also be plumbed into other baffles to supplement the average buoyancy of such baffles if such a correction is required for attitude control, or for a general increase in the overall buoyancy of the airship. Conversely, natural gas may be fed out of the baffles and into the engines when necessary to decrease buoyancy.

The entire operation of the two heaters in each sorb may be automated to achieve the optimal control scheme with an optimal controller to set the temperature of the first and second sorbs using conventional feedback control technology, augmented by methods of predictive control. Pitch control of the airship is actuated by controlling the relative amount of absorption/desorption between the forward and aft double-sorb controllers to provide the buoyant force distribution in each of the two baffles that is necessary to achieve the desired pitch control. Additional sorbs may be placed elsewhere on modified airship designs to affect roll control as discussed above, but this added complexity will not be necessary in conventional airship designs that are roll-stabilized by the weight distribution and the symmetry of the airship envelope. A sorb that is optimized for use with methane gas will be used, with one such implementation being the use of zeolite compounds, another being the use of activated carbon absorbers, and yet another possibility is being a carbon nanotube powder sorb. The choice of the sorb material is set by convenience and the thermophysical properties of the sorb, so the selection of a different sorb material does not represent a new overall invention, since such substitutions are obvious to those skilled in the art. The sorb material is thermally anchored to the sorb temperature-controlled stage using appropriate adhesive or other material to assure that the sorb is cooled adequately by the sorb state prior to saturation of the sorb by the absorbent. The gas used within the vacuum space sorb may also be methane, or it may be another gas with a slightly lower condensation temperature, such as nitrogen. Here again, the selection of this material is set by convenience, and hence substitution of this material for another is obvious to one skilled in the art.

While particular embodiment of the present invention has been illustrated and described, the present invention should not be limited to such illustrations and descriptions. It should be apparent that some changes and modifications may be incorporated and embodied as a part of the present invention within the scope of the following claims. In particular, substitution of natural gas (methane) with hydrogen as the buoyant gas controlled by a double-sorb controller for use in the transport of liquid hydrogen, or any other vapor-liquid system such that the vapor is lighter than air, is obvious to one skilled in this art, and does not represent an independent invention. It is also obvious that the subject invention may be used in concert with some fixed amount of another buoyant gas, such as helium, where the use of the natural gas system detailed above is used to bring the airship up to neutral buoyancy in dedicated natural gas baffles, and to provide adjustment of the amount of natural gas between these baffles as necessary to provide attitude control, again as detailed above. In such a multi-gas airship the helium or other lighter than air gas may be used to provide some fraction, such as 90%, of the ship's buoyancy at its point of departure, and this volume of this helium gas will remain constant throughout the flight. The methane system described herein would be used to make up the remaining buoyancy to control the airship about its neutrally buoyant point throughout flight.

What is claimed is:

1. A system of the airship buoyancy adjustment and differential buoyancy attitude control using the liquefied or solidified gas payload.

2. The system according to claim 1 wherein said liquefied or solidified gas payload is methane, hydrogen, helium or all others such that the resulting boil-off is lighter than ambient air.

3. The system according to claim 1 wherein said airship buoyancy adjustment and differential buoyancy attitude correction using said liquefied or solidified gas payload is combined with system of natural gas or hydrogen gas fueling engines.

4. The system according to claim 3 wherein said airship buoyancy adjustment and differential attitude control combined with said natural gas or hydrogen gas fueling engines is provided with double-sorb controllers.

5. The system according to claim 4 wherein said double-sorb controllers are connected with said liquefied or solidified gas payload, natural gas or hydrogen gas engines, and dedicated baffles located in the nose and tail of the airship.

6. The system according to claim 4 wherein said double-sorb controllers have the first and second sorbs equipped with heaters and separated by vacuum space and thermally conductive hermetic shell.

7. The system according to claim 6 wherein said first sorb is connected with the airship's baffle, and said second sorb is connected with the vacuum space which separates the cryogenic payload from the inner (first) sorb system.

8. A predictive active control system using the distributed double-sorbs heater controllers to provide fine control of the buoyancy and attitude of the airship, including pitch and roll, through the control of both heaters in all of the double-sorb units within the airship.

9. A system of automated valves that may be used to increase the overall buoyancy in each baffle to provide course adjustment of the airship's overall buoyancy and attitude control.
